(19) United States
(12) Patent Application Publication
(10) Pub. No.: US 2026/0108024 A1
(43) Pub. Date: Apr. 23, 2026

(54) TORSION COIL SPRING, METHOD FOR MANUFACTURING SAME, FASTENER FOR ACCESSORY, METHOD FOR MANUFACTURING SAME, AND ACCESSORY

(71) Applicant: Crossfor Co., Ltd., Kofu-shi, Yamanashi (JP)

(72) Inventor: Hidetaka DOBASHI, Kofu-shi (JP)

(73) Assignee: Crossfor Co., Ltd., Kofu-shi, Yamanashi (JP)

(21) Appl. No.: 19/117,677

(22) PCT Filed: Mar. 19, 2024
(86) PCT No.: PCT/JP2024/010688

§ 371 Date: Apr. 2, 2025

(30) Foreign Application Priority Data
Aug. 1, 2023 (JP) 2023-125740

(51) Int. Cl. A44C 5/18; F16F 1/12

(52) U.S. Cl. CPC A44C 5/185; F16F 1/12

(57) ABSTRACT

A torsion coil spring capable of suppressing decrease in rotational biasing force that is applied to two members coupled to each other in a rotatable manner. A torsion coil spring includes a coil portion, and a first arm portion, and a second arm portion extending respectively from a first end portion and a second end portion of the coil portion. The first arm portion includes an insertion portion that is inserted into a hole provided in the first member, a first intermediate portion, and a first bent portion. The second arm portion includes an engaging portion that is engaged with a step portion of the recessed portion provided in the second member, a second intermediate portion, and a second bent portion. As viewed in a direction that is perpendicular to a center line of the coil portion.

### TECHNICAL FIELD

The present invention relates to a torsion coil spring, a method for manufacturing the same, an accessory fastener, a method for manufacturing the same, and an accessory.

### BACKGROUND

As fasteners (also called clasps) to be used for coupling a cord-like member (such as chain) of accessories such as a necklace, fasteners of various types such as a spring-ring type, a plug-in type, and a screw type have been known. In addition, fasteners having a rotary structure that enters an open state and a closed state through interaction of its two members coupled to each other in a rotatable manner also have been known (refer to Japanese Patent Application Laid-open No. 09-299117).

### SUMMARY

Leaf springs are generally used as simple elastic means for biasing the two members coupled to each other in a rotatable manner. However, sizes of the fasteners to be used as those of the accessories are small, and hence it is difficult for the leaf springs to generate sufficient biasing force. Meanwhile, torsion coil springs are capable of generating larger elastic force than leaf springs of the same size, and hence the torsion coil springs may be used as elastic means of the fasteners.

At a time when the torsion coil spring is used in the fastener, normally, a rotary shaft (shaft) is inserted through a hole of a coil portion that is formed by winding a wire member into a coil shape. FIG. 10 is a view illustrating a case where a general torsion coil spring is used in a fastener. The fastener illustrated in FIG. 10 includes two members 701 and 702 coupled to each other in a rotatable manner with a shaft 800, and a torsion coil spring 600. The torsion coil spring 600 includes a coil portion 603 through which the shaft 800 is inserted, and two arm portions 601 and 602 extending from both ends of the coil portion 603. A leading end of the arm portion 601 pushes a right-hand end of an inner surface of the member 701, and a leading end of the arm portion 602 pushes a left-hand end of an inner surface of the member 702.

As illustrated in FIG. 10, force F with which the two arm portions 601 and 602 push the two members 701 and 702 generates unnecessary force that is applied to cause the shaft 800 to rotate leftward as viewed in a direction perpendicular to a rotation center line Lr that extends through a rotation center of the shaft 800. This unnecessary force does not contribute to rotation of the members 701 and 702 about the rotation center line Lr, and increases friction at sliding parts between the member 701 or the member 702 and the shaft 800. This causes problems such as a decrease in biasing force and a decrease in durability of mechanisms relating to the rotation.

The present invention has been made in view of such circumstances, and an object thereof is to provide a torsion coil spring capable of suppressing decrease in rotational biasing force that is applied to two members coupled to each other in a rotatable manner, and a method for manufacturing the same, to provide an accessory fastener that uses such a torsion coil spring, and a method for manufacturing the same, and to provide an accessory including such an accessory fastener.

According to a first aspect of the present invention, there is provided a torsion coil spring that generates biasing force which causes a first member and a second member to rotate relative to each other, the first member and the second member being coupled to each other in a rotatable manner, the torsion coil spring including:
a coil portion formed of a wire member wound into a helical shape;
a first arm portion extending from a first end portion of the coil portion; and
a second arm portion extending from a second end portion of the coil portion,
the first arm portion including
   an insertion portion that is inserted into a hole provided in the first member,
   a first intermediate portion that connects the first end portion and the insertion portion to each other, and
   a first bent portion that is bent between the insertion portion and the first intermediate portion,
the second arm portion including
   an engaging portion that is engaged with a step portion provided in the second member,
   a second intermediate portion that connects the second end portion and the engaging portion to each other, and
   a second bent portion that is bent between the second intermediate portion and the engaging portion,
a coil hole at a center of the coil portion having a circular shape as viewed in a center-line direction that is parallel to a center line of the helical shape,
the first end portion being located behind the center line as viewed in a first direction that is perpendicular to the center line,
the second end portion being located behind the center line as viewed in a second direction that is perpendicular to the center line,
the first intermediate portion
   extending, as viewed in the center-line direction, along a first tangent line that is tangent to the circular shape of the coil hole,
   being tangent, as viewed in the first direction, to a first perpendicular line that is perpendicular to the center line, and
   extending, as viewed in the first direction, in a direction that is away from the center line as a distance from the first end portion increases,
the insertion portion
   extending, as viewed in the center-line direction, in a direction
      that is away from the first tangent line as a distance from the first bent portion increases, and
      that is toward a side opposite to a side where the coil hole is located relative to the first tangent line, and
   extending, as viewed in the first direction, in a direction
      that is away from the first perpendicular line as the distance from the first bent portion increases, and
      that is toward a side where the coil portion is located relative to the first perpendicular line,
the second intermediate portion
   extending, as viewed in the center-line direction, along a second tangent line that is tangent to the circular shape of the coil hole,
   being tangent, as viewed in the second direction, to a second perpendicular line that is perpendicular to the center line, and
   extending, as viewed in the second direction, in a direction that is away from the center line as a distance from the second end portion increases,
the engaging portion extending, as viewed in the second direction, parallel to the center line and in a direction
   that is away from the second perpendicular line as a distance from the second bent portion increases, and
   that is toward a side where the coil portion is located relative to the second perpendicular line.

According to a second aspect of the present invention, there is provided a method for manufacturing the torsion coil spring according to the first aspect, the method including:
a coil-portion forming step of forming the coil portion by winding the wire member into the helical shape;
a first-arm-portion forming step of forming the first arm portion; and
a second-arm-portion forming step of forming the second arm portion,
the first-arm-portion forming step including a first bending step of bending a part of the wire member at the first bent portion, the part extending from the first end portion,
the second-arm-portion forming step including a second bending step of bending another part of the wire member at the second bent portion, the other part extending from the second end portion,
the first bending step including bending the part of the wire member at the first bent portion, the part extending from the first end portion, so that a part to be the insertion portion
   extends, as viewed in the center-line direction, in the direction
      that is away from the first tangent line as the distance from the first bent portion increases, and
      that is toward the side opposite to the side where the coil hole is located relative to the first tangent line, and
   extends, as viewed in the first direction, in the direction
      that is away from the first perpendicular line as the distance from the first bent portion increases, and
      that is toward the side where the coil portion is located relative to the first perpendicular line,
the second bending step including bending the other part of the wire member at the second bent portion, the other part extending from the second end portion, so that a part to be the engaging portion extends, as viewed in the second direction, parallel to the center line and in the direction
   that is away from the second perpendicular line as the distance from the second bent portion increases, and
   that is toward the side where the coil portion is located relative to the second perpendicular line.

According to a third aspect of the present invention, there is provided an accessory fastener including:
a first member and a second member coupled to each other in a rotatable manner; and
the torsion coil spring according to the first aspect, the torsion coil spring generating the biasing force which causes the first member and the second member to rotate relative to each other.

According to a fourth aspect of the present invention, there is provided a method for manufacturing an accessory fastener including
a first member and a second member coupled to each other in a rotatable manner, and
the torsion coil spring according to the first aspect, the torsion coil spring generating the biasing force which causes the first member and the second member to rotate relative to each other, the method including:
a step of preparing the torsion coil spring;
a step of preparing the first member and the second member coupled to each other in the rotatable manner; and
a step of pushing the torsion coil spring between the first member and the second member
   until the insertion portion held in abutment against the first member is inserted into the hole of the first member, and
   until the engaging portion held in abutment against the second member is engaged with the step portion of the second member.

According to a fifth aspect of the present invention, there is provided an accessory including the accessory fastener according to the third aspect.

### Advantageous Effects of Invention

According to the present invention, it is possible to provide a torsion coil spring capable of suppressing decrease in rotational biasing force that is applied to two members coupled to each other in a rotatable manner, and a method for manufacturing the same, to provide an accessory fastener that uses such a torsion coil spring, and a method for manufacturing the same, and to provide an accessory including such an accessory fastener.

### BRIEF DESCRIPTION OF DRAWINGS

FIG. 1 FIG. 1A and FIG. 1B are views illustrating an example of a torsion coil spring according to an embodiment of the present invention.

FIG. 2 FIG. 2A to FIG. 2C are views illustrating the example of the torsion coil spring according to the embodiment.

FIG. 3 is a view illustrating an example in which two members coupled to each other in a rotatable manner are biased with use of the torsion coil spring.

FIG. 4 FIG. 4A is a view illustrating an example of an accessory including a fastener according to a second embodiment. FIG. 4B is a perspective view illustrating an example of the fastener in an open state.

FIG. 5 FIG. 5A and FIG. 5B are views illustrating an example of a first member. FIG. 5C and FIG. 5D are views illustrating an example of a second member.

FIG. 6 FIG. 6A is a side view of a fastener, and FIG. 6B is a plan view of the fastener.

FIG. 7 FIG. 7A is a cross-sectional view of an internal structure of the fastener, and FIG. 7B is a rear view of the fastener.

FIG. 8 FIG. 8A is an explanatory flowchart showing an example of a method for manufacturing the torsion coil spring according to the embodiment. FIG. 8B is an explanatory flowchart showing an example of a procedure for forming arm portions.

FIG. 9 FIG. 9A and FIG. 9B are explanatory views illustrating an example of a method for manufacturing the fastener according to the embodiment.

FIG. 10 is a view of an accessory fastener that uses a related-art torsion coil spring.

### DETAILED DESCRIPTION OF EMBODIMENTS

### First Embodiment

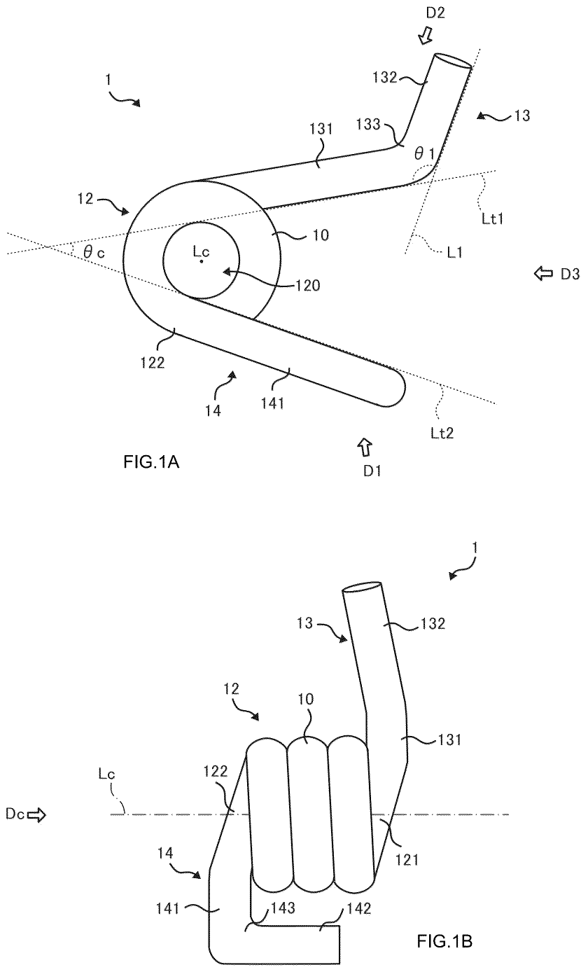

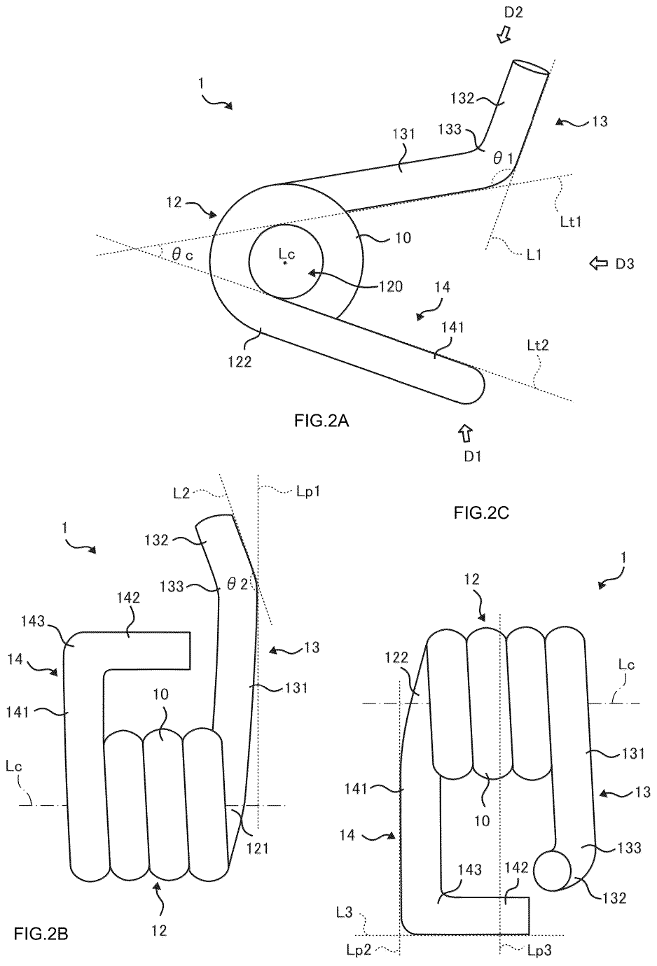

FIG. 1A and FIG. 1B and FIG. 2A to FIG. 2C illustrate an example of a torsion coil spring according to an embodiment of the present invention. This torsion coil spring 1 according to this embodiment is used for generating biasing force that causes two members (first member 21 and second member 22 described below) to rotate relative to each other, the two members being coupled to each other in a rotatable manner. As illustrated in FIGS. 1A and 1B, the torsion coil spring 1 includes a coil portion 12 formed of a wire member 10 wound into a helical shape, a first arm portion 13 extending from a first end portion 121 being one end portion of the coil portion 12, and a second arm portion 14 extending from a second end portion 122 being another end portion of the coil portion 12.

“Dc” in FIG. 1B denotes a direction that is parallel to a center line Lc of the helical shape of the coil portion 12 (hereinbelow, referred to as a “center-line direction Dc”). “D1,” “D2,” and “D3” in FIG. 1A and FIG. 2A each denote a direction that is perpendicular to the center line Lc (hereinbelow, “D1,” “D2,”, and “D3” are respectively referred to as a “first direction D1,” a “second direction D2,” and a “third direction D3”).

FIG. 1A and FIG. 2A are views in which the torsion coil spring 1 is viewed in the center-line direction Dc. FIG. 1B is a view in which the torsion coil spring 1 is viewed in the third direction D3. FIG. 2B is a view in which the torsion coil spring 1 is viewed in the first direction D1. FIG. 2C is a view in which the torsion coil spring 1 is viewed in the second direction D2.

### (Coil Portion 12)

As in the example illustrated in FIG. 1B, FIG. 2B, and FIG. 2C, the coil portion 12 is formed by winding the wire member 10 approximately three point five times into the helical shape. Although the coil portion 12 is formed by tight winding in this example, the coil portion 12 may be formed by other winding methods that do not cause parts of the wire member 10 to be brought into tight contact with each other. As illustrated, for example, in FIG. 1B, a central hole of the coil portion 12 as viewed in the center-line direction Dc (hereinbelow, referred to as a “coil hole 120”) has a substantially circular shape. The center line Lc extends through a center of the circular shape.

“Lt1” and “Lt2” in FIG. 1A and FIG. 2A denote tangent lines to the circular shape of the coil hole 120 as viewed in the center-line direction Dc (hereinbelow, respectively referred to as a “first tangent line Lt1” and a “second tangent line Lt2”).

### (First Arm Portion 13)

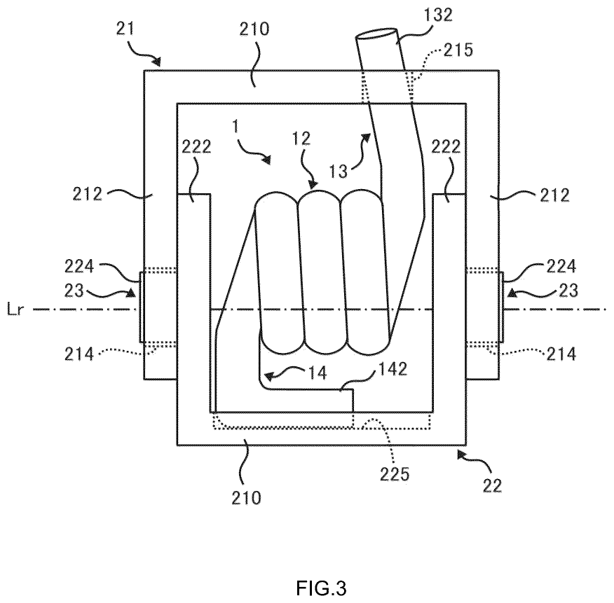

As illustrated, for example, in FIG. 1B, the first arm portion 13 includes an insertion portion 132, a first intermediate portion 131, and a first bent portion 133. The insertion portion 132 is inserted into a hole 215 (FIG. 3) described below of the first member 21. The first intermediate portion 131 connects the first end portion 121 and the insertion portion 132 of the coil portion 12 to each other. The first bent portion 133 is a bent part between the first intermediate portion 131 and the insertion portion 132.

As illustrated in FIG. 2B, as viewed in the first direction D1, the first end portion 121 of the coil portion 12, the first end portion 121 being continuous with the first intermediate portion 131, is located behind the center line Lc. The first direction D1 is a direction that is perpendicular to the center line Lc, and as illustrated in FIG. 2A, is also a direction that is substantially perpendicular to the first tangent line Lt1.

As illustrated in FIG. 2A, as viewed in the center-line direction Dc, the first intermediate portion 131 extends along the first tangent line Lt1 that is tangent to the circular shape of the coil hole 120. In addition, as illustrated in FIG. 2B, as viewed in the first direction D1, the first intermediate portion 131 is tangent to a perpendicular line Lp1 that is perpendicular to the center line Lc (hereinbelow, referred to as a “first perpendicular line Lp1”). Further, the first intermediate portion 131 extends in a direction that is away from the center line Lc as a distance from the first end portion 121 increases (upward direction in FIG. 2A).

As illustrated in FIG. 2A, as viewed in the center-line direction Dc, the insertion portion 132 extends in a direction that is away from the first tangent line Lt1 as a distance from the first bent portion 133 increases, and that is toward a side opposite to a side where the coil hole 120 is located relative to the first tangent line Lt1 (upper side relative to the first tangent line Lt1 in FIG. 2A). In the example illustrated in FIG. 2A, the insertion portion 132 as viewed in the center-line direction Dc extends along a straight line L1.

In addition, as illustrated in FIG. 2B, as viewed in the first direction D1, the insertion portion 132 extends in a direction that is away from the first perpendicular line Lp1 as the distance from the first bent portion 133 increases, and that is toward a side where the coil portion 12 is located relative to the first perpendicular line Lp1 (left-hand side relative to the first perpendicular line Lp1 in FIG. 2B). In the example illustrated in FIG. 2B, the insertion portion 132 as viewed in the first direction D1 extends along a straight line L2.

As illustrated in FIG. 2A, the first arm portion 13 is bent at the first bent portion 133 so that the first intermediate portion 131 and the insertion portion 132 form an obtuse angle as viewed in the center-line direction Dc. Specifically, as viewed in the center-line direction Dc, an angle θ1 (FIG. 2A) to be formed between the straight line L1 representing the extending direction of the insertion portion 132 and the first tangent line Lt1 substantially falls within a range of more than 90° and smaller than 180°.

In addition, as illustrated in FIG. 2B, the first arm portion 13 is bent at the first bent portion 133 so that the first intermediate portion 131 and the insertion portion 132 form another obtuse angle as viewed in the first direction D1. Specifically, as viewed in the first direction D1, an angle θ2 (FIG. 2B) to be formed between the straight line L2 representing the extending direction of the insertion portion 132 and the first perpendicular line Lp1 substantially falls within the range of more than 90° and smaller than 180°.

### (Second Arm Portion 14)

As illustrated, for example, in FIG. 1B, the second arm portion 14 includes an engaging portion 142, a second intermediate portion 141, and a second bent portion 134. The engaging portion 142 is engaged with a step (FIG. 3) described below of a recessed portion 225 provided in the second member 22. The second intermediate portion 141 connects the second end portion 122 and the engaging portion 142 of the coil portion 12 to each other. The second bent portion 134 is a bent part between the second intermediate portion 141 and the engaging portion 142.

As illustrated in FIG. 2C, as viewed in the second direction D2, the second end portion 122 of the coil portion 12, the second end portion 122 being continuous with the second intermediate portion 141, is located behind the center line Lc. The second direction D2 is a direction that is perpendicular to the center line Lc, and as illustrated in FIG. 2A, is also a direction that is substantially perpendicular to the second tangent line Lt2.

As illustrated in FIG. 2A, as viewed in the center-line direction Dc, the second intermediate portion 141 extends along the second tangent line Lt2 that is tangent to the circular shape of the coil hole 120. In addition, as illustrated in FIG. 2C, as viewed in the second direction D2, the second intermediate portion 141 is tangent to a perpendicular line Lp2 that is perpendicular to the center line Lc (hereinbelow, referred to as a “second perpendicular line Lp2”). Further, the second intermediate portion 141 extends in a direction that is away from the center line Lc as a distance from the second end portion 122 increases (downward direction in FIG. 2C).

As illustrated in FIG. 2C, as viewed in the second direction D2, the engaging portion 142 extends substantially parallel to the center line Lc and in a direction that is away from the second perpendicular line Lp2 as a distance from the second bent portion 134 increases, and that is toward a side where the coil portion 12 is located relative to the second perpendicular line Lp2 (right-hand side relative to the second perpendicular line Lp2 in FIG. 2C).

As illustrated in FIG. 2C, as viewed in the second direction D2, the engaging portion 142 has a length that reaches a perpendicular line Lp3 which extends through the center of the coil portion 12 and which is perpendicular to the center line Lc (hereinbelow, referred to as a “third perpendicular line Lp3”).

As illustrated in FIG. 2C, the second arm portion 14 is bent at the second bent portion 134 so that the second intermediate portion 141 and the engaging portion 142 form a substantially right angle as viewed in the second direction D2.

Note that, as illustrated in FIG. 2A, an angle θc that the first tangent line Lt1 and the second tangent line Lt2 form relative to the coil hole 120 is an acute angle.

FIG. 3 is a view illustrating an example in which the two members coupled to each other in the rotatable manner (first member 21 and second member 22) are biased with use of the above-described torsion coil spring 1. The first member 21 and the second member 22 are coupled to each other in a turnable manner with two coupling portions 23, and are rotatable relative to each other about a rotation center line Lr. FIG. 3 is a view in a direction that is perpendicular to the rotation center line Lr.

The first member 21 has the hole 215 into which the insertion portion 132 is inserted, and the second member 22 has the recessed portion 225 in which the step portion to be engaged with the engaging portion 142 is formed. The torsion coil spring 1 is held between the first member 21 and the second member 22 with the insertion portion 132 inserted and with the engaging portion 142 engaged with the step portion of the recessed portion 225. In this state, the center line Lc of the torsion coil spring 1 and the rotation center line Lr are substantially parallel to each other.

The first member 21 includes a top plate portion 210 through which the hole 215 is formed, and two first side-plate portions 212 provided at both edges of the top plate portion 210. In addition, the second member 22 includes a bottom plate portion 220 in which the recessed portion 225 that forms the step portion is provided, and two second side-plate portions 222 provided at both edges of the bottom plate portion 220. One of the first side-plate portions 212 and one of the second side-plate portions 222 are coupled to each other with one of the coupling portions 23, and another one of the first side-plate portions 212 and another one of the second side-plate portions 222 are coupled to each other with another one of the coupling portions 23. In the example illustrated in FIG. 3, the coupling portions 23 each have a protruding portion 224 provided to the second side-plate portion 222, and a coupling hole 214 provided through the first side-plate portion 212. The protruding portion 224 is inserted in the coupling hole 214, and the protruding portion 224 is rotatable in the coupling hole 214.

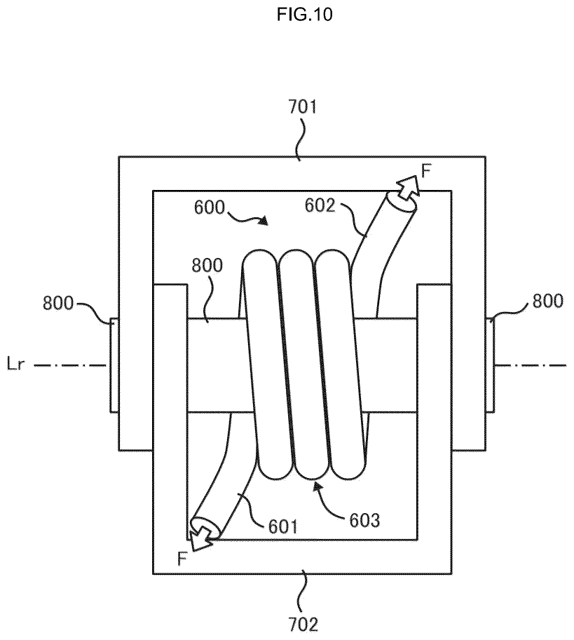

According to this embodiment, as illustrated in FIG. 2B, as viewed in the first direction D1, the insertion portion 132 extends in the direction that is away from the first perpendicular line Lp1 as the distance from the first bent portion 133 increases, and that is toward the side where the coil portion 12 is located relative to the first perpendicular line Lp1. In addition, as illustrated in FIG. 2C, as viewed in the second direction D2, the engaging portion 142 extends in the direction that is away from the second perpendicular line Lp2 as the distance from the second bent portion 134 increases, and that is toward the side where the coil portion 12 is located relative to the second perpendicular line Lp2. In other words, as illustrated in FIG. 1B, positions of the insertion portion 132 and the engaging portion 142 are closer to a central side of the coil portion 12 as viewed in the direction that is perpendicular to the center line Lc than the arm portions 601 and 602 of the related-art torsion coil spring 600 illustrated in FIG. 10 are close. With this, under a state in which the torsion coil spring 1 is arranged between the first member 21 and the first member 21 so that the center line Lc of the coil portion 12 and the rotation center line Lr are parallel to each other, the insertion portion 132 and the engaging portion 142 cause a direction of the biasing force that is applied to the first member 21 and the first member 21 to be closer to a direction that is orthogonal to the rotation center line Lr than that of the related-art torsion coil spring 600 illustrated in FIG. 10. As the biasing force by the torsion coil spring 1 becomes closer to the direction that is orthogonal to the rotation center line Lr, unnecessary force that is applied to cause rotation centers of the two coupling portions 23 to shift from the rotation center line Lr (force that does not contribute to the rotation of the first member 21 and the second member 22 about the rotation center line Lr) becomes smaller. With this, friction at a sliding part of each of the coupling portions 23 (sliding part between the protruding portion 224 and the coupling hole 214) decreases. As a result, it is advantageously possible to suppress a decrease in the rotational biasing force to be applied to the first member 21 and the second member 22. In addition, unnecessary force to be applied to the coupling portions 23 decreases, and hence it is possible to suppress a decrease in durability.

According to this embodiment, as illustrated in FIG. 3, the insertion portion 132 of the first arm portion 13 is inserted in the hole 215 of the first member 21, and the engaging portion 142 of the second arm portion 14 is engaged with the step portion formed in the recessed portion 225 of the second member 22. Thus, even when a shaft, specifically, a rotary shaft is not inserted in the coil portion 12 as illustrated in FIG. 10, the torsion coil spring 1 can be prevented from being disengaged from the first member 21 and the second member 22. In addition, the engagement between the engaging portion 142 of the second arm portion 14 and the step portion of the second member 22 enables the second arm portion 14 to be held by the second member 22. Thus, the second arm portion 14 is easily fitted to the second member 22. This enables the arm portions of the torsion coil spring 1 to be easily fitted to the first member 21 and the second member 22.

According to this embodiment, as illustrated in FIG. 2A, as viewed in the center-line direction Dc, the insertion portion 132 extends in the direction that is away from the first tangent line Lt1 as the distance from the first bent portion 133 increases, and that is toward the side opposite to the side where the coil hole 120 is located relative to the first tangent line Lt1. With this, under the state in which the torsion coil spring 1 is arranged between the first member 21 and the first member 21, the insertion portion 132 can be easily inserted into the hole 215 of the first member 21.

In addition, at the first bent portion 133 of the first arm portion 13, the first arm portion 13 is bent so that the first intermediate portion 131 and the insertion portion 132 form the obtuse angles as viewed respectively in the center-line direction Dc and the first direction D1 (FIG. 2A and FIG. 2B). This enables the insertion portion 132 to be more easily inserted into the hole 215 of the first member 21 than in a case where the angles are acute angles.

According to this embodiment, as illustrated in FIG. 2C, as viewed in the second direction D2, the engaging portion 142 extends parallel to the center line Lc. Thus, under the state in which the torsion coil spring 1 is arranged between the second member 22 in which the step portion of the recessed portion 225 extends parallel to the rotation center line Lr and the first member 21 so that the center line Lc and the rotation center line Lr are parallel to each other, the engaging portion 142 extending parallel to the center line Lc and the step portion of the recessed portion 225 extending parallel to the rotation center line Lr are engaged with each other. With this, even when the first member 21 and the second member 22 are rotated about the rotation center line Lr, the step portion of the recessed portion 225 and the engaging portion 142 are kept parallel to each other, and hence are prevented from being disengaged from each other.

According to this embodiment, as illustrated in FIG. 2C, as viewed in the second direction D2, the second arm portion 14 is bent so that the second intermediate portion 141 and the engaging portion 142 form the right angle at the second bent portion 134. This enables a width in the center-line direction Dc of the torsion coil spring 1 to be reduced to be smaller than that of the related-art torsion coil spring as illustrated in FIG. 10.

According to this embodiment, as illustrated in FIG. 2C, as viewed in the second direction D2, the engaging portion 142 has the length that reaches the third perpendicular line Lp3 (perpendicular line that extends through the center of the coil portion 12 and is perpendicular to the center line Lc). This enables force with which the second member 22 is pushed via the engaging portion 142 to be applied to a position of the third perpendicular line Lp3 (to a vicinity of the center of the coil portion 12). Thus, the direction of the biasing force that is applied to the first member 21 and the first member 21 can be caused to be close to the direction that is orthogonal to the rotation center line Lr.

According to this embodiment, as illustrated in FIG. 2A, the angle that the first tangent line Lt1 and the second tangent line Lt2 form relative to the coil hole 120 is an acute angle. This prevents the first arm portion 13 and the first arm portion 13 from being obstacles at a time when the torsion coil spring 1 is inserted between the first member 21 and the second member 22. Thus, assembly work of fitting the arm portions of the torsion coil spring 1 to the first member 21 and the second member 22 is facilitated.

According to this embodiment, as illustrated in FIG. 3, the one of the first side-plate portions 212 and the one of the second side-plate portions 222 are coupled to each other with the one of the coupling portions 23, and the other one of the first side-plate portions 212 and the other one of the second side-plate portions 222 are coupled to each other with the other one of the coupling portions 23. In addition, at least a part of the torsion coil spring 1 is located between the two first side-plate portions 212 of the first member 21, and is located between the two second side-plate portions 222 of the second member 22. This enables the first member 21, the second member 22, and the torsion coil spring 1 to be more easily assembled to each other than in the structure as illustrated in FIG. 10 in which the shaft 800 is inserted through the coil portion 603.

### Second Embodiment

Next, a second embodiment of the present invention is described.

The second embodiment relates to an accessory fastener in which the above-described torsion coil spring 1 (FIG. 1A and FIG. 1B and FIG. 2A to FIG. 2C) is used as biasing means.

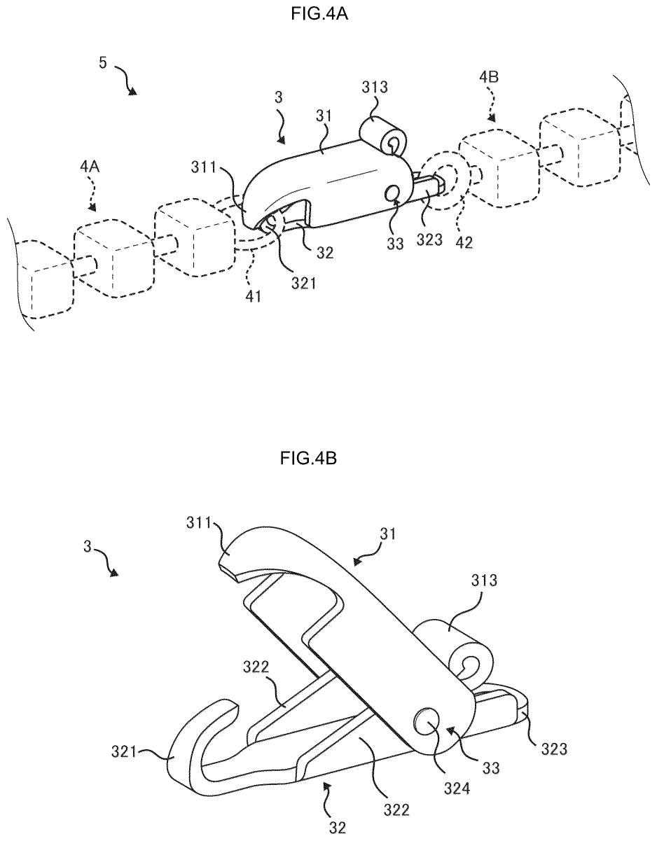

FIG. 4A is a view illustrating an example of an accessory 5 including a fastener 3 that uses the torsion coil spring 1 according to this embodiment. The accessory 5 illustrated in FIG. 4A is, for example, a necklace or a bracelet, and includes separate cord-like members 4A and 4B, and the fastener 3 that links these members into an annular shape. FIG. 4B illustrates the fastener 3 in an open state.

As illustrated in FIG. 4A and FIG. 4B, the fastener 3 includes a first member 31 and a second member 32 coupled to each other in a rotatable manner, two coupling portions 33 that couple the first member 31 and the second member 32 to each other, and an operating portion 313 that is used in an operation to rotate the first member 31 and the second member 32.

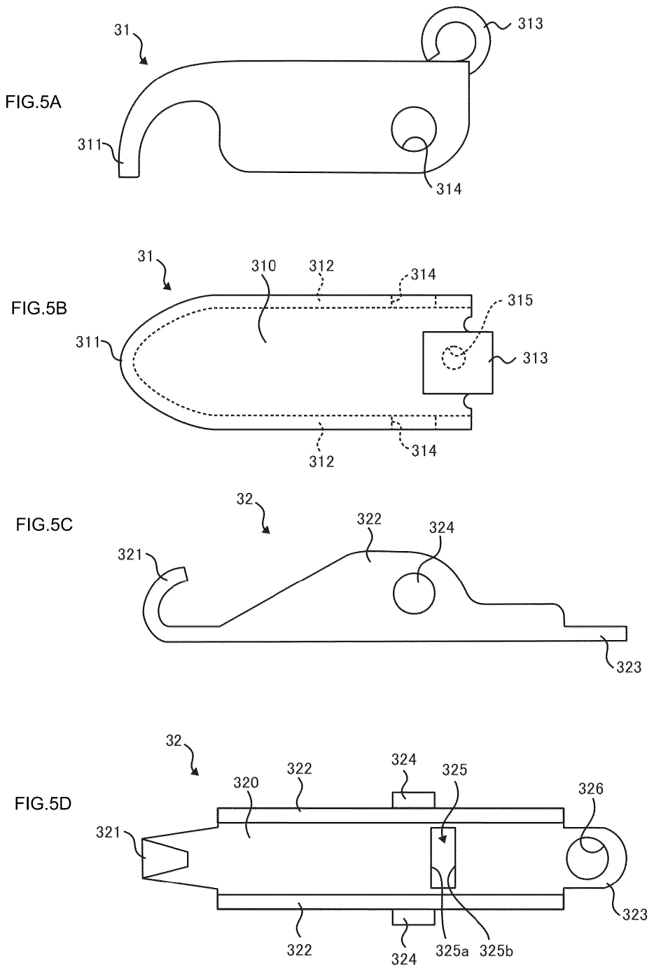

FIG. 5A is a side view of the first member 31, and FIG. 5B is a plan view of the first member 31. As illustrated in FIG. 5A and FIG. 5B, the first member 31 includes a front-side edge portion 311 curved into a hook shape as viewed from the side, a top plate portion 310 expanding from a top side to a rear side of the front-side edge portion 311, and two first side-plate portions 312 expanding from lateral sides to the rear side of the front-side edge portion 311. The two first side-plate portions 312 extend downward from right-hand and left-hand side edges of the top plate portion 310. At an end on the rear side of the top plate portion 310, a hole 315 into which the insertion portion 132 of the torsion coil spring 1 is inserted is formed.

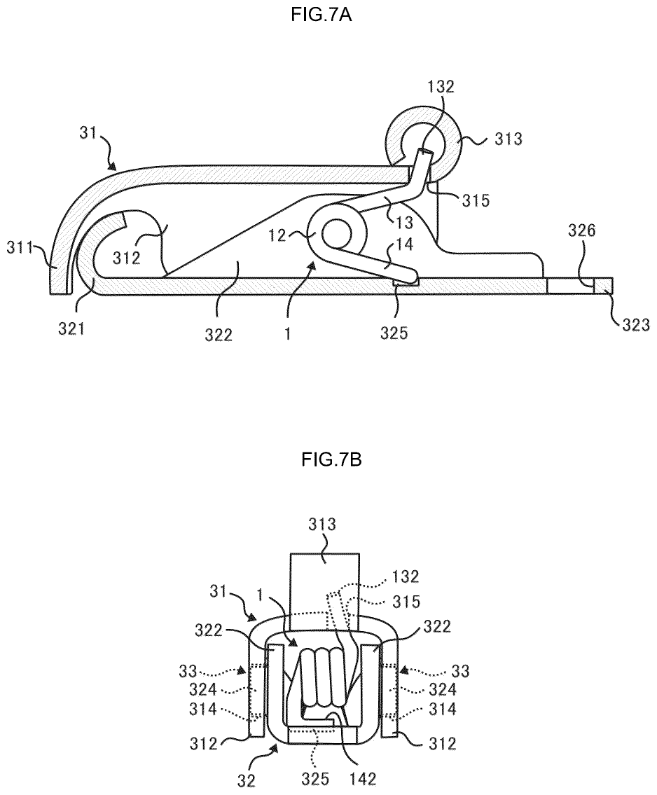

The operating portion 313 is provided on a rear side of an outer surface of the top plate portion 310. As illustrated in FIG. 5B, on the outer surface of the top plate portion 310 as viewed along a direction in which the hole 315 is formed, the operating portion 313 covers a range including the hole 315. In addition, as illustrated in FIG. 7A and FIG. 7B to be referred to below, the operating portion 313 is capable of covering also a range including the insertion portion 132 protruding through the hole 315. In the example illustrated in FIG. 5A, the operating portion 313 is formed of a plate-like member extending from an edge on the rear side of the top plate portion 310 and curved backward to a front side of the top plate portion 310. The operating portion 313 is curved into a ring shape as viewed from the side, and covers the hole 315 formed through the top plate portion 310.

Coupling holes 314 are formed respectively through the two first side-plate portions 312 of the first member 31. Protruding portions 324 described below of the second member 32 are inserted into the coupling holes 314.

FIG. 5C is a side view of the second member 32, and FIG. 5D is a plan view of the second member 32. As illustrated in FIG. 5C and FIG. 5D, the second member 32 includes a front-side edge portion 321 curved into a hook shape as viewed from the side, a bottom plate portion 320 expanding from a bottom to a rear side of the front-side edge portion 321, two second side-plate portions 322 expanding from lateral sides to the rear side of the front-side edge portion 321, and an attachment portion 323 provided at an end on a rear side of the bottom plate portion 320. The two second side-plate portions 322 extend upward from right-hand and left-hand side edges of the bottom plate portion 320. The attachment portion 323 has an attachment hole 326 for attaching a ring member 42 at an end of the cord-like member 4B.

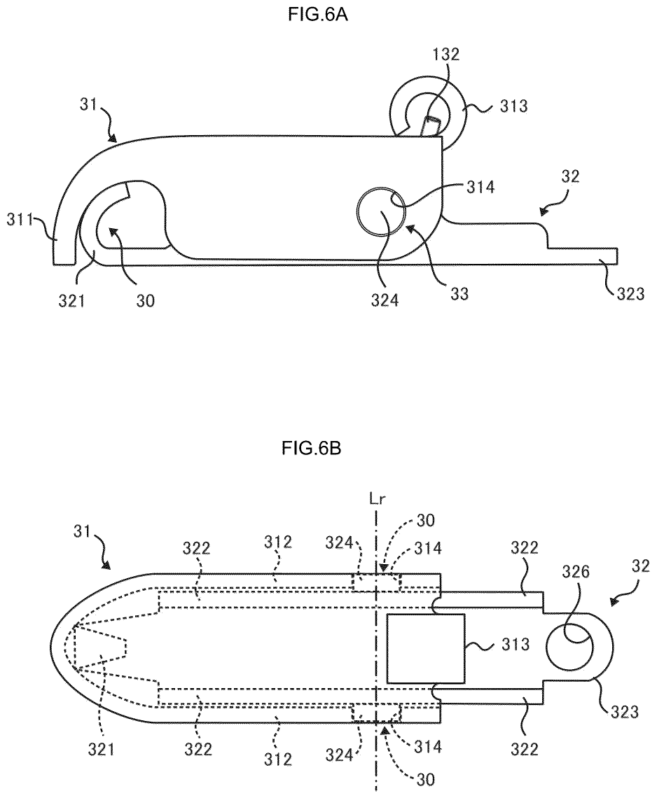

The two second side-plate portions 322 of the second member 32 respectively include the protruding portions 324 protruding outward. The two protruding portions 324 are respectively inserted into the coupling holes 314 of the first side-plate portions 312. One of the coupling holes 314 and one of the protruding portions 324 to be inserted thereinto constitute one of the coupling portions 33. The first member 31 and the second member 32 are coupled to each other in the rotatable manner about the rotation center line Lr (FIG. 6B) with the two coupling portions 33 (coupling holes 314 and protruding portions 324).

As illustrated in FIG. 5D, a recessed portion 325 is formed in an inner surface (surface on a side that faces the first member 31) of the bottom plate portion 320 of the second member 32. The recessed portion 325 includes step portions 325a and 325b extending parallel to the rotation center line Lr (FIG. 6B) of the two coupling portions 33. These step portions 325a and 325b are engaged with the engaging portion 142 of the torsion coil spring 1.

FIG. 6A is a side view of the fastener 3, and FIG. 6B is a plan view of the fastener 3. FIG. 7A is a cross-sectional view of an internal structure of the fastener 3, and FIG. 7B is a rear view of the fastener 3. Under the state in which the fastener 3 has been closed, the front-side edge portion 311 of the first member 31 and the front-side edge portion 321 of the second member 32 are held in abutment against each other. As illustrated in FIG. 6A, a closed space 30 surrounded by the first member 31 and the second member 32 is formed. Under the state in which the fastener 3 has been opened, as illustrated in FIG. 4B, a gap is formed between the front-side edge portion 311 and the front-side edge portion 321, and a ring member 41 can be inserted into and removed from the closed space 30 through this gap. In order to connect the fastener 3 to the ring member 41 of the cord-like member 4A as illustrated in FIG. 4A, the fastener 3 is opened, and the ring member 41 is hooked to the front-side edge portion 321 that is curved into a hook shape. Then, the fastener 3 is closed. In this way, the ring member 41 is inserted into the closed space 30, and is prevented from getting out of the closed space. In order to disengage the fastener 3 from the ring member 41, the fastener 3 is opened, and the ring member 41 is removed through the gap between the front-side edge portion 311 and the front-side edge portion 321. Then, the fastener 3 is closed.

By elastic force of the torsion coil spring 1, the first member 31 and the second member 32 are biased to rotate relative to each other into a direction in which the fastener 3 is closed. In order to open the first member 31 and the second member 32 that have been closed, force is applied to the operating portion 313 provided to the first member 31 by applying a finger or the like to the operating portion 313. With this, the first member 31 and the second member 32 are rotated relative to each other against the biasing force of the torsion coil spring 1. By discontinuation of the application of the force to the operating portion 313, the first member 31 and the second member 32 are closed again automatically.

As illustrated in FIG. 7A and FIG. 7B, the torsion coil spring 1 is arranged in the interior space of the fastener 3 (space surrounded by the first member 31 and the second member 32) with the insertion portion 132 inserted in the hole 315 of the first member 31 and with the engaging portion 142 engaged with the step portions 325a and 325b of the recessed portion 325 of the second member 32. At least a part of the torsion coil spring 1 (part including the coil portion 12 in the illustrated example) is located between the two first side-plate portions 312, and located between the two second side-plate portions 322. The center line Lc of the coil portion 12 of the torsion coil spring 1 is substantially parallel to the rotation center line Lr (FIG. 6B).

According to this embodiment, as in the first embodiment (FIG. 3), the torsion coil spring 1 is arranged in the first member 31 and the second member 32 (FIG. 7B) so that the center line Lc of the coil portion 12 and the rotation center line Lr are parallel to each other. The insertion portion 132 and the engaging portion 142 cause the direction of the biasing force that is applied to the first member 31 and the second member 32 to be closer to the direction that is orthogonal to the rotation center line Lr than that of the related-art torsion coil spring 600 illustrated in FIG. 10. As a result, it is advantageously possible to suppress a decrease in the rotational biasing force to be applied to the first member 31 and the second member 32. In addition, unnecessary force to be applied to the coupling portions 33 decreases, and hence it is possible to suppress a decrease in durability.

According to this embodiment, on an outer surface of the first member 31 as viewed in the direction in which the hole 315 is formed, the range including the hole 315 and the range including the insertion portion 132 protruding through the hole 315 are covered with the operating portion 313 (FIG. 7A and FIG. 7B). This enables the operating portion 313 to implement not only its original function to facilitate the rotation of the first member 31 and the second member 32 with a finger or the like, but also a function to prevent the finger or other objects from coming into contact with the insertion portion 132 protruding through the hole 315. Thus, the configuration of the fastener 3 can be more simplified than in a case of providing another member that prevents the contact with the insertion portion 132.

According to this embodiment, as illustrated in FIG. 7A and FIG. 7B, the insertion portion 132 of the first arm portion 13 is inserted in the hole 315 of the first member 31, and the engaging portion 142 of the second arm portion 14 is engaged with the step portions 325a and 325b formed in the recessed portion 325 of the second member 32. Thus, even when the shaft, specifically, the rotary shaft is not inserted in the coil portion 12 as illustrated in FIG. 10, the torsion coil spring 1 can be prevented from being disengaged from the first member 31 and the second member 32. In addition, the engagement between the engaging portion 142 of the second arm portion 14 and the step portions 325a and 325b of the second member 32 enables the second arm portion 14 to be held by the second member 32. This enables the arm portions of the torsion coil spring 1 to be easily fitted to the first member 31 and the second member 32.

According to this embodiment, as illustrated in FIG. 5D and FIG. 6B, the step portions 325a and 325b of the second member 32 extend parallel to the rotation center line Lr, and as illustrated in FIG. 7A and FIG. 7B, the torsion coil spring 1 is arranged between the first member 31 and the second member 32 so that the center line Lc and the rotation center line Lr are parallel to each other. In addition, as illustrated in FIG. 2C, as viewed in the second direction D2, the engaging portion 142 extends parallel to the center line Lc. Thus, even when the first member 21 and the second member 22 are rotated about the rotation center line Lr, the step portions 325a and 325b of the second member 32 and the engaging portion 142 are kept parallel to each other, and hence are prevented from being disengaged from each other.

According to this embodiment, as illustrated in FIG. 6B and FIG. 7B, one of the first side-plate portions 312 and one of the second side-plate portions 322 are coupled to each other with one of the coupling portions 33, and another one of the first side-plate portions 312 and another one of the second side-plate portions 322 are coupled to each other with another one of the coupling portions 33. In addition, at least a part of the torsion coil spring 1 is located between the two first side-plate portions 212 of the first member 21, and is located between the two second side-plate portions 222 of the second member 22. This enables the first member 31, the second member 32, and the torsion coil spring 1 to be more easily assembled to each other than in the structure as illustrated in FIG. 10 in which the shaft 800 is inserted through the coil portion 603.

Next, a method for manufacturing the above-described torsion coil spring 1 according to the embodiments is described.

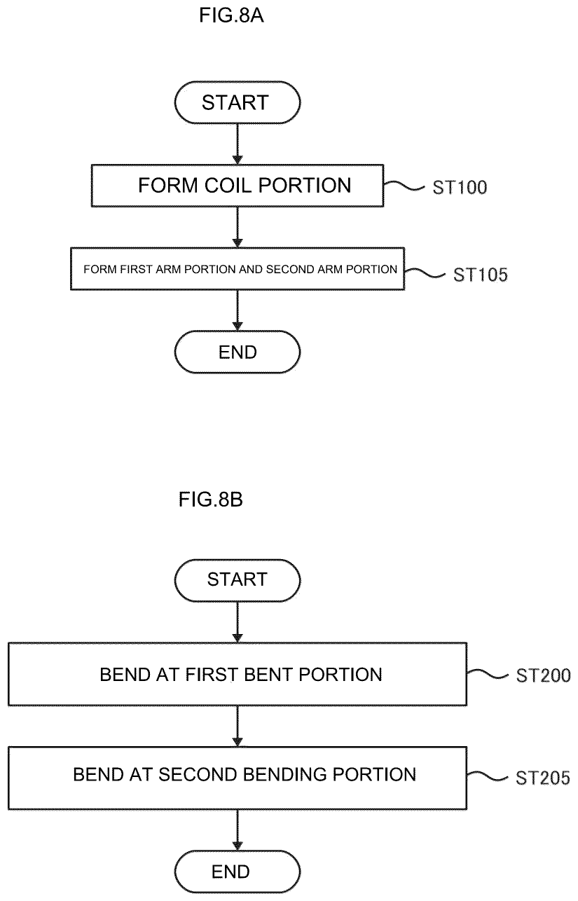

FIG. 8A is an explanatory flowchart showing an example of the method for manufacturing the torsion coil spring 1. In the manufacturing method shown in FIG. 8A, first, the coil portion 12 is formed by winding the wire member 10 into a helical shape (ST100). Next, the first arm portion 13 and the second arm portion 14 extending respectively from the first end portion 121 and the second end portion 122 of the coil portion 12 are formed (ST105).

FIG. 8B is an explanatory flowchart showing an example of the step of forming the first arm portion 13 and the second arm portion 14 (ST105 in FIG. 8A).

### ST200:

A step of forming the first arm portion 13 includes a step of bending a part of the wire member 10 at the first bent portion 133, the part extending from the first end portion 121 of the coil portion 12 (first bending step).

In this first bending step, as illustrated in FIG. 2A, the part of the wire member 10, the part extending from the first end portion 121, is bent at the first bent portion 133 so that, as viewed in the center-line direction Dc, a part to be the insertion portion 132 extends in the direction that is away from the first tangent line Lt1 as the distance from the first bent portion 133 increases, and that is toward the side opposite to the side where the coil hole 120 is located relative to the first tangent line Lt1. In addition, in the first bending step, as illustrated in FIG. 2B, the part of the wire member 10, the part extending from the first end portion 121, is bent at the first bent portion 133 so that, as viewed in the first direction D1, the part to be the insertion portion 132 extends in the direction that is away from the first perpendicular line Lp1 as the distance from the first bent portion 133 increases, and that is toward the side where the coil portion 12 is located relative to the first perpendicular line Lp1.

### ST205:

A step of forming the second arm portion 14 includes a step of bending another part of the wire member 10 at the second bent portion 134, the other part extending from the second end portion 122 of the coil portion 12 (second bending step).

In this second bending step, as illustrated in FIG. 2C, the other part of the wire member 10, the other part extending from the second end portion 122, is bent at the second bent portion 134 so that, as viewed in the second direction D2, a part to be the engaging portion 142 extends parallel to the center line Lc and in the direction that is away from the second perpendicular line Lp2 as the distance from the second bent portion 134 increases, and that is toward the side where the coil hole 120 is located relative to the second perpendicular line Lp2.

Note that, the order of the first bending step of Step ST200 and the second bending step of Step ST205 may be reversed to each other, or these steps may be concurrently carried out. In addition, the above-described steps of the method for manufacturing the torsion coil spring 1 may be carried out by hand, and at least a part of the steps may be carried out with use of a machine tool.

Next, a method for manufacturing the fastener 3 that uses the above-described torsion coil spring 1 according to the embodiments is described.

In this method for manufacturing the fastener 3, first, the above-described torsion coil spring 1 is prepared. The torsion coil spring 1 can be formed, for example, by the method shown in FIG. 8A and FIG. 8B.

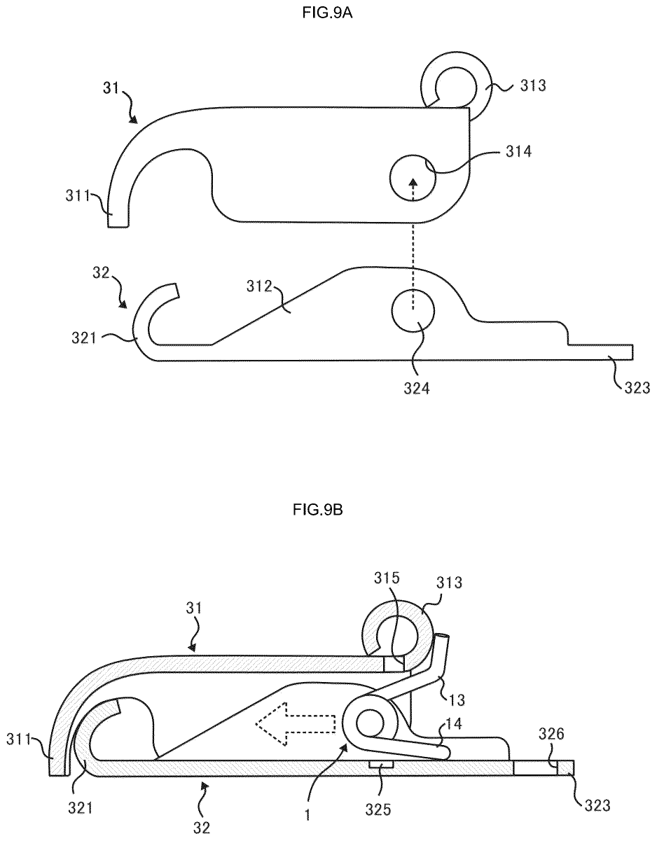

In addition, in this manufacturing method, the first member 31 and the second member 32 coupled to each other in the rotatable manner are prepared. The first member 31 (FIG. 5A and FIG. 5B) the second member 32 (FIG. 5C and FIG. 5D) are formed, for example, by pressing. As illustrated in FIG. 9A, the two protruding portions 324 of the second member 32 are inserted respectively into the two coupling holes 314 of the first member 31. In this way, the first member 31 and the second member 32 are assembled to be coupled to each other in the rotatable manner.

Then, the torsion coil spring 1 is fitted to the first member 31 and the second member 32 coupled to each other in the rotatable manner. Specifically, the torsion coil spring 1 is pushed between the first member 31 and the second member 32 until the insertion portion 132 held in abutment against with the first member 31 is inserted into the hole 315 of the first member 31, and until the engaging portion 142 held in abutment against with the second member 32 is engaged with the step portions 325a and 325b of the second member 32. For example, as illustrated in FIG. 9B, the torsion coil spring 1 is pushed into the first member 31 and the second member 32 through an opening portion to be formed on a rear side of the first member 31 and the second member 32 coupled to each other. The elastic force of the torsion coil spring 1 generates large force that causes the insertion portion 132 to be inserted into the hole 315 of the first member 31, and large force that causes the engaging portion 142 to be engaged with the step portions 325a and 325b of the second member 32. Thus, the torsion coil spring 1 is rigidly fitted to the first member 31 and the second member 32, and hence is not easily disengaged.

The embodiments described hereinabove are merely examples, and these embodiments encompass various other modifications.

For example, in the torsion coil spring according to the embodiments, the number of windings of the wire member of the coil portion, a thickness of the wire member, a cross-sectional shape of the wire member, a ratio between an outer shape and an inner diameter of the coil portion, the positions at which the arm portions are bent as viewed in the directions, the lengths of the straight parts of the arm portions as viewed in the directions, the bending angles of the straight parts of the arm portions as viewed in the directions, and the angle to be formed between the straight parts of the two arm portions are not limited to those in the examples illustrated, for example, in FIG. 1A and FIG. 1B and FIG. 2A to FIG. 2C.

The accessory fastener 3 need not necessarily be a fully assembled product as illustrated in FIG. 6A and FIG. 6B and FIG. 7A and FIG. 7B in the examples of the embodiments of the present invention. Specifically, the embodiments of the present invention encompass an assembly set for assembling accessory fasteners. An assembly set for the accessory fastener 3 illustrated in FIG. 6A and FIG. 6B and FIG. 7A and FIG. 7B includes the first member 31, the second member 32, and the torsion coil spring 1 as a biasing member.

In addition, the torsion coil spring according to the embodiments is applicable not only to the accessory fastener, but also, for example, to various other instruments. The torsion coil spring is particularly useful, for example, in instruments that require downsizing.

### REFERENCE SIGNS LIST

1 torsion coil spring
10 wire member
12 coil portion
120 coil hole
121 first end portion
122 second end portion
13 first arm portion
131 first intermediate portion
132 insertion portion
133 first bent portion
14 second arm portion
141 second intermediate portion
142 engaging portion
143 second bent portion
21 first member
210 top plate portion
212 first side-plate portion
214 coupling hole
215 hole
22 second member
220 bottom plate portion
222 second side-plate portion
224 protruding portion
225 recessed portion
23 coupling portion
3 fastener
31 first member
310 top plate portion
311 front-side edge portion
312 first side-plate portion
313 operating portion
314 coupling hole
315 hole
32 second member
320 bottom plate portion
321 front-side edge portion
322 second side-plate portion
323 attachment portion
324 protruding portion
325 recessed portion
325a, 325b step portion
33 coupling portion
4A cord-like member
4B cord-like member
41,41 ring member
5 accessory
Dc center-line direction
D1 first direction
D2 second direction
D3 third direction
Lc center line
Lt1 first tangent line
Lt2 second tangent line
Lp1 first perpendicular line
Lp2 second perpendicular line
Lp3 third perpendicular line
Lr rotation center line

1-12. (canceled)

13. A torsion coil spring that generates biasing force which causes a first member and a second member to rotate relative to each other, the first member and the second member being coupled to each other in a rotatable manner, the torsion coil spring comprising:
a coil portion formed of a wire member wound into a helical shape;
a first arm portion extending from a first end portion of the coil portion; and
a second arm portion extending from a second end portion of the coil portion,
the first arm portion including:
an insertion portion that is inserted into a hole provided in the first member,
a first intermediate portion that connects the first end portion and the insertion portion to each other, and
a first bent portion that is bent between the insertion portion and the first intermediate portion,
the second arm portion including:
an engaging portion that is engaged with a step portion provided in the second member,
a second intermediate portion that connects the second end portion and the engaging portion to each other, and
a second bent portion that is bent between the second intermediate portion and the engaging portion,
a coil hole at a center of the coil portion having a circular shape as viewed in a center-line direction that is parallel to a center line of the helical shape,
the first end portion being located behind the center line as viewed in a first direction that is perpendicular to the center line,
the second end portion being located behind the center line as viewed in a second direction that is perpendicular to the center line,
the first intermediate portion
extending, as viewed in the center-line direction, along a first tangent line that is tangent to the circular shape of the coil hole,
being tangent, as viewed in the first direction, to a first perpendicular line that is perpendicular to the center line, and
extending, as viewed in the first direction, in a direction that is away from the center line as a distance from the first end portion increases,
the insertion portion
extending, as viewed in the center-line direction, in a direction
that is away from the first tangent line as a distance from the first bent portion increases, and
that is toward a side opposite to a side where the coil hole is located relative to the first tangent line, and
extending, as viewed in the first direction, in a direction
that is away from the first perpendicular line as the distance from the first bent portion increases, and
that is toward a side where the coil portion is located relative to the first perpendicular line,
the second intermediate portion
extending, as viewed in the center-line direction, along a second tangent line that is tangent to the circular shape of the coil hole,
being tangent, as viewed in the second direction, to a second perpendicular line that is perpendicular to the center line, and
extending, as viewed in the second direction, in a direction that is away from the center line as a distance from the second end portion increases,
the engaging portion extending, as viewed in the second direction, parallel to the center line and in a direction
that is away from the second perpendicular line as a distance from the second bent portion increases, and
that is toward a side where the coil portion is located relative to the second perpendicular line.

14. The torsion coil spring according to claim 13, wherein the first arm portion is bent at the first bent portion so that the first intermediate portion and the insertion portion form obtuse angles as viewed respectively in the center-line direction and the first direction.

15. The torsion coil spring according to claim 13, wherein the second arm portion is bent at the second bent portion so that the second intermediate portion and the engaging portion form a right angle as viewed in the second direction.

16. The torsion coil spring according to claim 13, wherein, as viewed in the second direction, the engaging portion has a length that reaches a third perpendicular line which extends through the center of the coil portion and which is perpendicular to the center line.

17. The torsion coil spring according to claim 13, wherein an angle that the first tangent line and the second tangent line form relative to the coil hole is an acute angle.

18. A method for manufacturing the torsion coil spring according to claim 13, the method comprising:
a coil-portion forming step of forming the coil portion by winding the wire member into the helical shape;
a first-arm-portion forming step of forming the first arm portion; and
a second-arm-portion forming step of forming the second arm portion,
the first-arm-portion forming step including a first bending step of bending a part of the wire member at the first bent portion, the part extending from the first end portion,
the second-arm-portion forming step including a second bending step of bending another part of the wire member at the second bent portion, the other part extending from the second end portion,
the first bending step including bending the part of the wire member at the first bent portion, the part extending from the first end portion, so that a part to be the insertion portion
extends, as viewed in the center-line direction, in the direction
that is away from the first tangent line as the distance from the first bent portion increases, and
that is toward the side opposite to the side where the coil hole is located relative to the first tangent line, and
extends, as viewed in the first direction, in the direction
that is away from the first perpendicular line as the distance from the first bent portion increases, and
that is toward the side where the coil portion is located relative to the first perpendicular line,
the second bending step including bending the other part of the wire member at the second bent portion, the other part extending from the second end portion, so that a part to be the engaging portion extends, as viewed in the second direction, parallel to the center line and in the direction
that is away from the second perpendicular line as the distance from the second bent portion increases, and
that is toward the side where the coil portion is located relative to the second perpendicular line.

19. An accessory fastener, comprising:
a first member and a second member coupled to each other in a rotatable manner; and
the torsion coil spring according to claim 13, the torsion coil spring generating the biasing force which causes the first member and the second member to rotate relative to each other.

20. The accessory fastener according to claim 19,
wherein the first member and the second member are rotatable relative to each other about a rotation center line, and
wherein the center line of the torsion coil spring and the rotation center line are parallel to each other.

21. The accessory fastener according to claim 19, further comprising two coupling portions that couple the first member and the second member to each other in the rotatable manner,
wherein the first member includes two first side-plate portions facing each other,
wherein the second member includes two second side-plate portions facing each other,
wherein one of the two first side-plate portions and one of the two second side-plate portions are coupled to each other with one of the two coupling portions,
wherein another one of the two first side-plate portions and another one of the two second side-plate portions are coupled to each other with another one of the two coupling portions, and
wherein at least a part of the torsion coil spring
is located between the two first side-plate portions, and
is located between the two second side-plate portions.

22. The accessory fastener according to claim 19, further comprising an operating portion
that is provided on an outer surface of the first member, and
that is used in an operation to rotate the first member relative to the second member, wherein, on the outer surface of the first member as viewed in a direction in which the hole is formed, the operating portion covers a range including at least
the hole, and
the insertion portion protruding through the hole.

23. A method for manufacturing an accessory fastener including
a first member and a second member coupled to each other in a rotatable manner, and
the torsion coil spring according to any one of claim 13, the torsion coil spring generating the biasing force which causes the first member and the second member to rotate relative to each other, the method comprising:
a step of preparing the torsion coil spring;
a step of preparing the first member and the second member coupled to each other in the rotatable manner; and
a step of pushing the torsion coil spring between the first member and the second member
until the insertion portion held in abutment against the first member is inserted into the hole of the first member, and
until the engaging portion held in abutment against the second member is engaged with the step portion of the second member.

24. An accessory comprising the accessory fastener according to claim 19.
